(19) United States
(12) Patent Application Publication
(10) Pub. No.: US 2022/0281717 A1
(43) Pub. Date: Sep. 8, 2022

(54) ELEVATOR BRAKE WEAR DETECTION METHOD, DETECTION DEVICE AND ELEVATOR BRAKE

(71) Applicant: Otis Elevator Company, Farmington, CT (US)

(72) Inventors: Guosong Li, Tianjin (CN); Hua Zhou, Tianjin (CN)

(21) Appl. No.: 17/522,357

(22) Filed: Nov. 9, 2021

(30) Foreign Application Priority Data
Mar. 8, 2021 (CN) 202110251008.5

(51) Int. Cl. B66B 5/18; B66B 5/00; B66B 1/32

(52) U.S. Cl. CPC B66B 5/18; B66B 5/0031; B66B 1/32

(57) ABSTRACT

An elevator brake wear detection method, an elevator brake wear detection device and an elevator brake. The elevator brake includes a fixed part with an electromagnetic member and a moving part with a friction member; in a first state, the elevator brake drives the moving part to move toward an elevator power device and contact the elevator power device through the friction member to provide a braking force to stop an elevator car, and in a second state, the elevator brake provides an electromagnetic force through the electromagnetic member to disengage the friction member from the contact with the elevator power device.

### FOREIGN PRIORITY

This application claims priority to Chinese Patent Application No. 202110251008.5, filed Mar. 8, 2021, and all the benefits accruing therefrom under 35 U.S.C. § 119, the contents of which in its entirety are herein incorporated by reference.

### TECHNICAL FIELD

The present disclosure relates to the technical field of elevators, in particular to an elevator brake wear detection method, an elevator brake wear detection device and an elevator brake.

### BACKGROUND

An elevator brake is a safety braking device in an elevator. It plays an important role in ensuring the safe operation of elevators and the personal safety of passengers. An existing elevator system 100 is shown in FIG. 1. Generally, an elevator power device 20 (such as a traction machine, etc.), an elevator brake 10 and other devices may be disposed in an elevator machine room 400, and the elevator power device 20 is connected with an elevator car 200 through a rope 300 so as to provide power to the elevator car 200 so that the elevator car 200 is driven to move up and down in an elevator hoistway, and to stop at the passenger's target floor by operating the elevator brake, such as Fa, Fb or Fc, etc., shown in FIG. 1. In addition, in the event of an elevator failure, emergency accident, etc., the elevator car can also be safely braked through the elevator brake.

As shown in FIG. 2, typically, the elevator brake mainly includes a fixed part 1 and a moving part 2 which is capable of moving relative to the fixed part 1 according to operational requirements. The fixed part 1 can be fixedly installed in the elevator machine room 400, and a force F1 is provided by a component 5 (such as a spring, etc.) arranged between the fixed part 1 and the moving part 2 to drive the moving part 2 to move in a direction away from the fixed part 1, so that a friction member 4 located on the moving part 2 is enabled to contact a braking member 6 (such as a rotating wheel, a turntable, etc.) associated with the elevator power device 20 and that a braking force is provided, thereby making the elevator power device 20 stop outputting power to achieve the purpose of safe braking of the elevator car. In addition, an electromagnetic force F2 in an opposite direction to the force F1 may also be applied by means of an electromagnetic member 3 located at the fixed part 1 to urge the moving part 2 to move in a direction toward the fixed part 1, thereby disengaging the friction member 4 from the contact with the elevator power device 20, so that the power output of the elevator power device 20 is restored and the elevator car can operate again.

For example, in a repeated operational process described above, the friction member in the elevator brake will gradually wear out, which will not only affect the braking performance of the elevator, but may also lead to safety risk. Therefore, in the prior art, it is necessary to arrange professionals to carry professional tools such as feeler gauges for regular on-site inspections to ensure safety of devices. For example, these professionals are required to go to the elevator machine room to inspect the wear condition of the elevator brake every other two weeks. For one elevator brake, each time of on-site wear inspection often takes several minutes or more.

### SUMMARY

In view of the foregoing, the present disclosure provides an elevator brake wear detection method, an elevator brake wear detection device and an elevator brake, so as to solve or at least alleviate one or more of the above-mentioned problems and other problems in the prior art.

Firstly, according to an aspect of the present disclosure, an elevator brake wear detection method is provided, wherein the elevator brake includes a fixed part with an electromagnetic member and a moving part with a friction member; in a first state, the elevator brake drives the moving part to move toward an elevator power device and contact the elevator power device through the friction member to provide a braking force to stop an elevator car, and in a second state, the elevator brake provides an electromagnetic force through the electromagnetic member to disengage the friction member from the contact with the elevator power device; the elevator brake wear detection method including the following steps: A. bringing the elevator brake into the first state, and inputting an electrical signal to the electromagnetic member to generate an electromagnetic field that passes through an air gap between the fixed part and the moving part; B. obtaining inductance data or inductance response data of the electromagnetic member under the electromagnetic field; and C. based on a preset correspondence model between the inductance of the electromagnetic member and the air gap in the first state, obtaining a corresponding air gap value according to the inductance data to determine a wear state of the friction member, or determining the wear state of the friction member according to the inductance response data.

In the elevator brake wear detection method according to the present disclosure, optionally, in step A, the electromagnetic member is one or more winding coils arranged in a circumferential direction of the fixed part, and the electrical signal is a sinusoidal wave pulse width modulated electrical signal input to the winding coil.

In the elevator brake wear detection method according to the present disclosure, optionally, in step B, the inductance data is calculated according to the following formula: L=(U/I−R)/2 π*f where U, I and R are a present voltage, present current and resistance of the electromagnetic member, respectively, and f is a frequency of the electrical signal.

In the elevator brake wear detection method according to the present disclosure, optionally, in step C, the correspondence model is a standard curve model constructed based on the corresponding data of the inductance of the electromagnetic member and the air gap in the first state which are obtained through detection; or the inductance response data includes current data of the electromagnetic member, a change of at least one current characteristic is judged according to the current data to determine the wear state of the friction member, and the current characteristics include current amplitude and current phase.

Optionally, the elevator brake wear detection method according to the present disclosure further includes the following steps: A. before step A is executed, confirming that the elevator car is currently in a stopped and empty state; and/or B. after step C is executed, outputting report information related to the wear state of the friction member.

In the elevator brake wear detection method according to the present disclosure, optionally, the report information is stored locally in the elevator or stored in a cloud server.

In the elevator brake wear detection method according to the present disclosure, optionally, when the obtained air gap value exceeds a first preset value, the report information is sent to a user end which includes user's mobile communication terminal; and/or A. when the obtained air gap value exceeds a second preset value, the elevator is controlled to stop running and/or the report information is sent to the user end, the second preset value being larger than the first preset value.

In the elevator brake wear detection method according to the present disclosure, optionally, an operating time of the elevator includes an idle period and a busy period, and steps A-C are automatically executed in the idle period with a preset time cycle.

In addition, according to another aspect of the present disclosure, an elevator brake wear detection device is also provided, wherein the elevator brake includes a fixed part with an electromagnetic member and a moving part with a friction member; in a first state, the elevator brake drives the moving part to move toward an elevator power device and contact the elevator power device through the friction member to provide a braking force to stop an elevator car, and in a second state, the elevator brake provides an electromagnetic force through the electromagnetic member to disengage the friction member from the contact with the elevator power device; the elevator brake wear detection device includes a controller which is configured to execute the following steps: A. bringing the elevator brake into the first state, and inputting an electrical signal to the electromagnetic member to generate an electromagnetic field that passes through an air gap between the fixed part and the moving part; B. obtaining inductance data or inductance response data of the electromagnetic member under the electromagnetic field; and C. based on a preset correspondence model between the inductance of the electromagnetic member and the air gap in the first state, obtaining a corresponding air gap value according to the inductance data to determine a wear state of the friction member, or determining the wear state of the friction member according to the inductance response data.

In the elevator brake wear detection device according to the present disclosure, optionally, the electromagnetic member is one or more winding coils arranged in a circumferential direction of the fixed part, and the electrical signal is a sinusoidal wave pulse width modulated electrical signal input to the winding coil.

In the elevator brake wear detection device according to the present disclosure, optionally, the controller is configured to calculate the inductance data according to the following formula: A. L=(U/I−R)/2 π*f where U, I and R are a present voltage, present current and resistance of the electromagnetic member, respectively, and f is a frequency of the electrical signal.

In the elevator brake wear detection device according to the present disclosure, optionally, the correspondence model is a standard curve model constructed based on the corresponding data of the inductance of the electromagnetic member and the air gap in the first state which are obtained through detection; or the inductance response data includes current data of the electromagnetic member, a change of at least one current characteristic is judged according to the current data to determine the wear state of the friction member, and the current characteristics include current amplitude and current phase.

In the elevator brake wear detection device according to the present disclosure, optionally, the controller is further configured to execute the following steps: A.before step A is executed, confirming that the elevator car is currently in a stopped and empty state; and/or B.after step C is executed, outputting report information related to the wear state of the friction member.

In the elevator brake wear detection device according to the present disclosure, optionally, the report information is stored locally in the elevator or stored in a cloud server.

In the elevator brake wear detection device according to the present disclosure, optionally, the controller is further configured to: A. when the obtained air gap value exceeds a first preset value, send the report information to a user end which includes user's mobile communication terminal; and/or B. when the obtained air gap value exceeds a second preset value, control the elevator is to stop running and/or send the report information to the user end, the second preset value being larger than the first preset value.

In the elevator brake wear detection device according to the present disclosure, optionally, an operating time of the elevator includes an idle period and a busy period, and the controller is configured to automatically execute steps A-C in the idle period with a preset time cycle.

In addition, according to further another aspect of the present disclosure, an elevator brake is also provided, which is provided with the elevator brake wear detection device as described in any one of the above items.

From the following detailed description combined with the accompanying drawings, the principles, features, characteristics and advantages of the technical solutions according to the present disclosure will be clearly understood. For example, the application of the solutions of the present disclosure can automatically, efficiently and accurately detect the present wear condition of the elevator brake at a low cost, thereby helping significantly reduce the cost of manual on-site check and maintenance, effectively promoting the timely and accurate stocking up of elements and components such as the friction member, and realizing a significant reduction in elevator maintenance expense and other expenses. The present disclosure has obvious practicability and very high application value.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structural configurations described herein, and are not required to be drawn to scale.

FIG. 1 is a schematic structural view of an existing elevator system, in which an example of an elevator power device and an example of an elevator brake are shown at the same time.

FIG. 2 is a schematic view of a basic structure and working principle of an existing elevator brake.

FIG. 3 is a schematic flowchart of an embodiment of an elevator brake wear detection method according to the present disclosure.

FIG. 4 is a schematic partial side view showing the structure of an example of an elevator brake when the embodiment of the elevator brake wear detection method according to the present disclosure is applied.

FIG. 5 is a schematic right-side view showing the structure of the example of the elevator brake shown in FIG. 4, with a friction member being omitted in the figure.

FIG. 6 shows a correspondence model between an inductance of an electromagnetic member and an air gap in an example of the elevator brake.

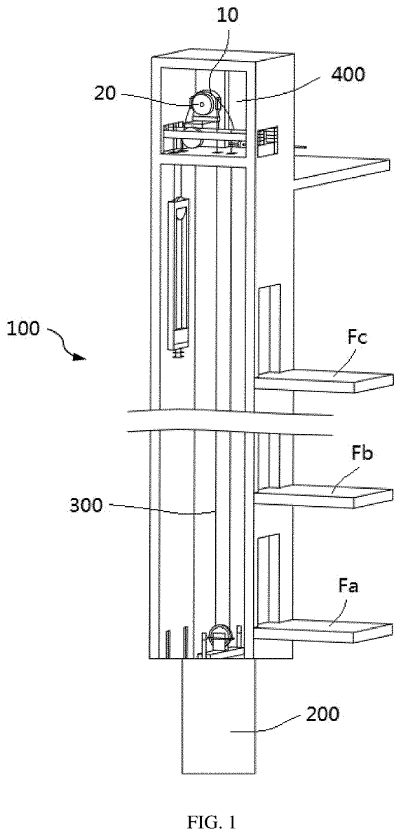

### DETAILED DESCRIPTION OF EMBODIMENT(S)

First, it should be noted that the steps, components, characteristics, advantages and the like of the elevator brake wear detection method, the elevator brake wear detection device and the elevator brake according to the present disclosure will be described below by way of example. However, it should be understood that neither of the descriptions should be understood as limiting the present disclosure in any way.

In addition, for any single technical feature described or implied in the embodiments mentioned herein or any single technical feature shown or implied in individual drawings, the present disclosure still allows for any combination or deletion of these technical features (or equivalents thereof) without any technical obstacle. Therefore, it should be considered that these more embodiments according to the present disclosure are also within the scope recorded in this document. In addition, for the sake of brevity, general items commonly known to those skilled in the art, such as the basic configurations and working principles of the elevator power device and the elevator brake will not be described in greater detail herein.

According to the design concept of the present disclosure, a method capable of automatically detecting a wear condition of an elevator brake is first provided. Reference is made to FIG. 3, a processing flow of an embodiment of the method according to the present disclosure is exemplarily shown, which may include the following steps:

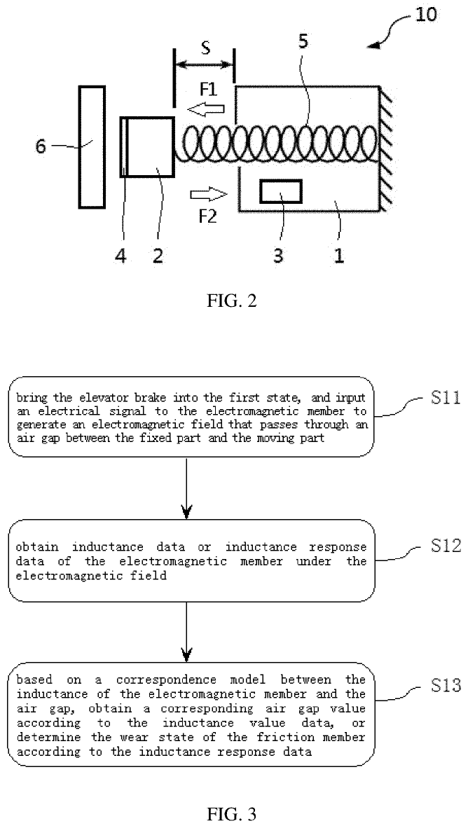

In step S11, the elevator brake may first be placed in a first state (also often referred to as a “braking state” or “brake drop state”, etc.), such as in the example of the elevator brake shown in FIG. 2; at this time, the conventional operating current may not be provided to an electromagnetic member 3 in a fixed part 1, so as to release an electromagnetic force F2 originally applied to a moving part 2 to place a friction member 4 and a braking member 6 in an out-of-contact state. Pushed by a force F1 provided by a component 5, the moving part 2 will move toward the braking member 6 in a guiding direction of a component 7 (such as a bolt, a pin, etc.), and then apply a braking force to the braking member 6 through the contact between the friction member 4 on the moving part 2 and the braking member 6, thereby prompting an elevator power device to stop outputting power outwardly. When the elevator brake is in the first state, there is an air gap S between the fixed part 1 and the moving part 2, which is schematically illustrated in FIGS. 2 and 3. In the prior art, professional tools such as feeler gauges are often directly used to measure the size of the air gap S. It should be understood that the actual size of the air gap S is related to the wear condition of the elevator brake. For example, with the frequent operation and use of the elevator brake, the friction member 4 will be gradually worn out, which will cause the air gap S to increase continuously.

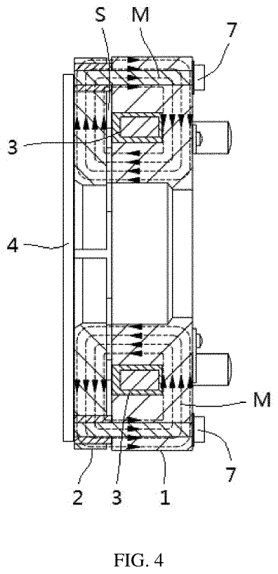

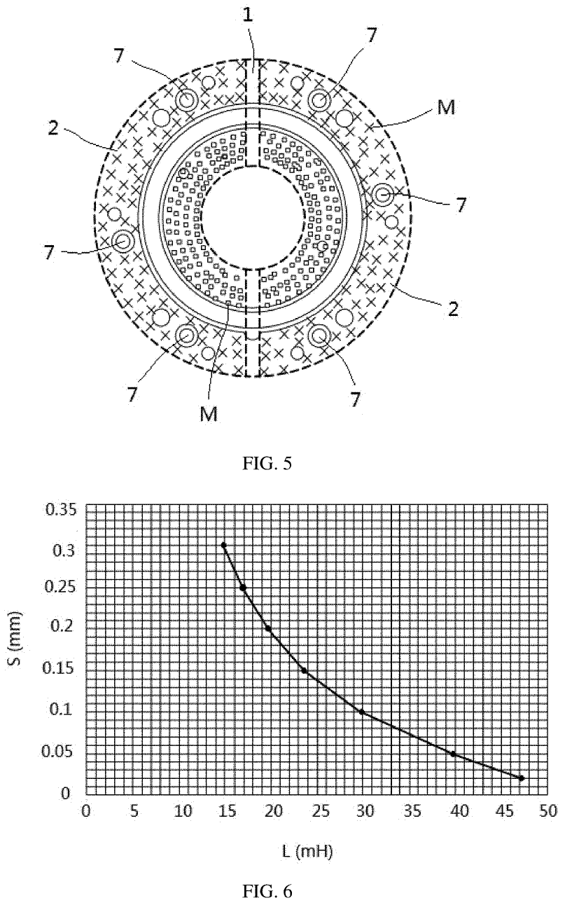

In step S11, an electromagnetic field M can then be formed by inputting an electrical signal to the electromagnetic member 3 in the elevator brake. Such an electromagnetic field M will pass through the air gap S between the fixed part 1 and the moving part 2. For example, as shown in FIGS. 4 and 5, the electromagnetic member 3 will generate magnetic lines of force under the excitation of the input electrical signal. These magnetic lines of force form an electromagnetic field M that can cover at least a part or even the entirety of each of the fixed part 1 and the moving part 2. It should be understood that although the electromagnetic member 3 can output a certain electromagnetic force at this time, the electromagnetic force is not enough to overcome the force applied to the moving part 2 by the component 5; therefore, it is ensured that the elevator brake is still in the first state, that is, the friction member 4 remains in contact with the braking member 6 at this time, so that the air gap S between the fixed part 1 and the moving part 2 and the actual wear condition of the elevator brake can be evaluated and analyzed later.

It should be noted that for the above electromagnetic member 3, the present disclosure allows for flexible setting and selections thereof according to actual application requirements in terms of the specific structure, configuration, components, arrangement position and installation method in the elevator brake, etc.; that is, there are no specific restrictions on this. As an exemplary illustration, for example, in some embodiments, one or more winding coils may be selected very conveniently and arranged in a circumferential direction of the fixed part 1. For example, four or six winding coils may be evenly arranged in the circumferential direction of the fixed part 1 at the same time, which not only helps promote outwardly providing and applying the electromagnetic force more evenly, but also provides a certain degree of redundancy at the same time, thereby improving the safety and reliability of the elevator brake.

It should also be pointed out that for the above electrical signal input to the electromagnetic member 3, the present disclosure also allows for flexible settings and selections thereof according to specific requirements, so as to provide the electromagnetic field M that passes through the air gap S discussed above. By way of example, as an optional solution, for example, a sinusoidal wave electrical signal, particularly a sinusoidal wave pulse width modulation (PWM) electrical signal may be selected for use. For this type of electrical signal provided to the electromagnetic member 3, it can be realized in various ways, such as by providing a corresponding PWM control module in a control part (such as an elevator frequency converter or an additional control circuit board and other software and hardware) for controlling the operation of the elevator brake in the elevator brake or in the elevator system, or by adding a circuit board with a PWM control function, etc.

With continued reference to FIG. 3, next in step S12, a present inductance value of the electromagnetic member 3 under the electromagnetic field M may be obtained, which will then be used to evaluate a present actual condition of the air gap S between the fixed part 1 and the moving part 2, so as to judge and analyze the present wear condition of elevator brake.

As an example, in step S12, the following formula may be used to quickly calculate the present inductance value of the electromagnetic member 3:

L=(U/I−R)/2 π*f

In the above formula, U and I are the present voltage and current of the electromagnetic member, respectively, R is the resistance of the electromagnetic member itself, and f is the frequency of the above electric signal input to the electromagnetic member. All the above data can be easily obtained. For example, as regards the present voltage and current of the electromagnetic member, they are used as the operating data of elevator devices, and can be directly obtained from the existing elevator brakes or control units, modules, devices or an operation management system in the elevator system.

As another example, in some embodiments, components such as an inductance sensor may also be equipped for the elevator brake, which is arranged at a suitable position in the elevator brake to directly collect and obtain the present inductance value of the electromagnetic member. In addition, the present inductance value of the electromagnetic member may also be calculated through a complex function relationship between the brake voltage and the brake current of the elevator brake; or changes in the amplitude margin and phase margin of the Bode diagram of the brake transfer function can be used to reflect the change in the present inductance of the electromagnetic member, and in this way, the degree of wear of the elevator brake can also be judged. Similarly, the present voltage, present current and other data of the electromagnetic member can also be collected by providing corresponding sensors and detectors in the elevator brake.

Next, in step S13, the inductance value of the electromagnetic member obtained in step S12 can be used to obtain the value of the air gap S corresponding to it, and to evaluate the present wear condition of the friction member based on the value of the air gap S. The above process can be performed with the help of a standard curve model of the correspondence between the inductance of the electromagnetic member and the air gap exemplarily shown in FIG. 6, that is, the corresponding value of the air gap S can be correspondingly obtained by searching according to a specific value of the inductance L.

Specifically, for a certain model of the elevator brake, multiple sets of data on the correspondence between the inductance of the electromagnetic member and the air gap S in the first state can be obtained through testing; for example, data testing may be performed based on multiple elevator brakes of the same model and with different wear conditions, so that such a correspondence model can be provided in advance for evaluation and use in step S13.

It can be understood that the above correspondence model may be constructed by self-measurement of data on site at the elevator device, or it may be directly obtained for example from manufacturers of elevator brakes or elevators, R&D institutions, equipment maintenance units, etc. In addition, in actual use, the above correspondence model may be stored in advance in any suitable component, unit, module or device in the elevator brake or elevator system. It may take various feasible forms such as charts, data fields, texts, etc., in order to be able to better meet the needs of a variety of different applications.

As discussed in detail in the above introduction, the inductance data of the electromagnetic member under the electromagnetic field can be used to determine the wear condition of the friction member. It should also be pointed out that the method of the present disclosure also allows for the analysis and processing of the wear condition of the friction member based on inductance response data of the electromagnetic member under the electromagnetic field. The inductance response data generally refers to physical characteristic data of the electromagnetic member after the response to the influence of the inductance characteristic under the electromagnetic field, such as current data. Specifically, when the electromagnetic member in the elevator brake is energized to generate an electromagnetic field, physical characteristics such as an operating current of the electromagnetic member will respond to the inductance characteristic of the electromagnetic member formed at this time, which will be reflected in specific data. That is, the inductance response data obtained in this situation already contains the result of the influence from the inductance associated with the air gap S. Therefore, by collecting and analyzing such inductance response data, the wear condition of the friction member can also be determined. For example, the change of one or more current characteristics (such as current amplitude, current phase, etc.) can be judged from the current data of the electromagnetic member, and then the wear condition of the friction member can be analyzed and determined, such as whether the decrease of the current amplitude is within a preset range, whether the offset of the current phase meets expectation and whether it is within a preset range, etc. If it is within the preset range, it indicates that the friction member is in a normal wear state (that is, the air gap S is currently normal); otherwise, it indicates that the wear condition has exceeded expectation (that is, the air gap S is currently too large), and so on. It should be understood that according to the above teachings of the present disclosure, those skilled in the art can make various flexible settings on the specific use of the inductance response data according to different application conditions.

By adopting the method of the present disclosure, the present wear condition of the friction member in the elevator brake can be learned timely, accurately and quickly; in particular, it is no longer necessary to arrange technicians to go to the device installation place of the elevator brake for on-site measurement. Since various types of elevator devices have been widely used in modern society, and the number of installations is quite large, the application of the solutions of the present disclosure can greatly reduce the large amount of labor and time costs currently invested in wear detection of each elevator brake, significantly reduce device maintenance costs, and help find device problems in time to actively and effectively take countermeasures, thereby enhancing the safety performance and service level of the elevator system.

It should be understood that the above embodiments are only exemplary description. Without departing from the spirit of the present disclosure, the method of the present disclosure allows more possible settings, changes and adjustments to be made according to different application requirements, to which there will be no restrictions at all.

For example, as an optional situation, a step of confirming whether the elevator car is currently in a stopped and empty state may be further added before the above step S11, that is, only after it is determined that the elevator car is suitable for the detection operation, will steps S11-S13 be executed, which helps enhance the safety of the entire detection operation.

For another example, as an optional situation, after step S13 is executed, report information related the obtained present wear condition of the elevator brake may be output outwardly; for example, such report information can be stored locally in the elevator or stored in a cloud server, so that elevator operation management personnel, equipment maintenance personnel, equipment manufacturers or parts suppliers can be informed in time. It can be understood that those skilled in the art can make flexible settings on the specific content, expression form, transmission path, level, etc., of the report information according to actual requirements.

For example, in some applications, if it is found that the value of the air gap S has exceeded the first preset value (which may be set or modified as needed) after the evaluation, the report information may be sent to the user end (such as a mobile phone, a PAD and other mobile communication terminals) in the form of text prompts, voice reminders, etc., so as to enable the user to grasp the present wear condition of the elevator brake in time. Therefore, preventive measures such as purchasing spare parts (e.g., the friction member) in advance ensure that the elevator system can operate safely and reliably for a long time. For another example, if it is found that the value of the air gap S has exceeded the second preset value (which is larger than the above-mentioned first preset value, and which may be set or modified as needed) after the evaluation, which indicates that the present wear condition of the elevator brake has exceeded an expected degree and may affect the safe braking operation of the elevator, multiple safety measures may be used individually or in combination at this time; for example, the elevator may be controlled to stop running, and the report information may be sent to the user end, etc., so as to achieve the effects of safety precautions and timely warning.

In addition, it should also be pointed out that the method of the present disclosure may be implemented as required; it may be performed in a one-time manner at any suitable time point, or may be implemented automatically with a preset time cycle (such as once every five days, once a week, once every two weeks, etc.). For example, as an alternative solution, the operating time of the elevator may be divided into a busy period (such as daytime working periods on working days) and an idle period (such as midnight periods on working days (such as 00:00-3:00, 01:00-2:00, etc.), or midnight periods on only non-working days), and then the method of the present disclosure is automatically performed only in the above idle period with a preset time cycle, so as to automatically track and grasp the wear condition of the elevator brake during the whole process, which will not cause any adverse effect on the normal operation and use of the elevator.

As another aspect that is significantly superior to the prior art, the present disclosure also provides an elevator brake wear detection device, which is provided with a controller for executing corresponding steps of the method according to the present disclosure discussed above for example. The elevator brake wear detection device can be manufactured and sold separately.

It can be understood that according to the disclosure of the present application, those skilled in the art may use, for example, processors, electronic circuits, integrated circuits (ASICs) and/or memories and combinational logic circuits for executing one or more software or firmware programs, and any other suitable element and component to realize the above-mentioned controller in the elevator brake wear detection device. In addition, since the technical contents of the elevator brake, various specific steps of elevator brake wear detection, the electrical signal input to the electromagnetic member and its implementation, the inductance data and the inductance response data, the setting and usage condition of the correspondence model between the inductance of the electromagnetic member and the air gap have been described in great detail in the above, reference may be directly made to specific description of the corresponding parts mentioned above, which will not be repeated herein.

In addition, according to the technical solutions of the present disclosure, an elevator brake is also provided. Specifically, the elevator brake may be equipped with the elevator brake wear detection device designed and provided according to the present disclosure, which can automatically, conveniently, efficiently and accurately detect the wear condition of the elevator brake, and significantly reduce elevator maintenance cost, so as to achieve these significant technical advantages as mentioned above. Therefore, the present disclosure has very high practical value and creates considerable economic benefits.

The elevator brake wear detection method, the elevator brake wear detection device and the elevator brake according to the present disclosure have been elaborated above in detail by way of example only. These examples are merely used to illustrate the principles and embodiments of the present disclosure, rather than limiting the present disclosure. Various modifications and improvements can be made by those skilled in the art without departing from the spirit and scope of the present disclosure. Therefore, all equivalent technical solutions should fall within the scope of the present disclosure and be defined by the claims of the present disclosure.

What is claimed is:

1. An elevator brake wear detection method, wherein the elevator brake comprises a fixed part with an electromagnetic member and a moving part with a friction member; in a first state, the elevator brake drives the moving part to move toward an elevator power device and contact the elevator power device through the friction member to provide a braking force to stop an elevator car, and in a second state, the elevator brake provides an electromagnetic force through the electromagnetic member to disengage the friction member from the contact with the elevator power device, and wherein the elevator brake wear detection method comprising:
bringing the elevator brake into the first state, and inputting an electrical signal to the electromagnetic member to generate an electromagnetic field that passes through an air gap between the fixed part and the moving part;
obtaining inductance data or inductance response data of the electromagnetic member under the electromagnetic field; and
based on a preset correspondence model between the inductance of the electromagnetic member and the air gap in the first state, obtaining a corresponding air gap value according to the inductance data to determine a wear state of the friction member, or determining the wear state of the friction member according to the inductance response data.

2. The elevator brake wear detection method according to claim 1, wherein in bringing the elevator brake into the first state, the electromagnetic member is one or more winding coils arranged in a circumferential direction of the fixed part, and the electrical signal is a sinusoidal wave pulse width modulated electrical signal input to the winding coil.

3. The elevator brake wear detection method according to claim 1, wherein in obtaining inductance data or inductance response data, the inductance data is calculated according to the following formula:
L=(U/I−R)/2 π*f
where U, I and R are a present voltage, present current and resistance of the electromagnetic member, respectively, and f is a frequency of the electrical signal.

4. The elevator brake wear detection method according to claim 1, wherein in obtaining the corresponding air gap value, the correspondence model is a standard curve model constructed based on the corresponding data of the inductance of the electromagnetic member and the air gap in the first state which are obtained through detection; or the inductance response data comprises current data of the electromagnetic member, a change of at least one current characteristic is judged according to the current data to determine the wear state of the friction member, and the current characteristics comprise current amplitude and current phase.

5. The elevator brake wear detection method according to claim 1, further comprising:
before bringing the elevator brake into the first state, confirming that the elevator car is currently in a stopped and empty state; and/or
after obtaining the corresponding air gap value, outputting report information related to the wear state of the friction member.

6. The elevator brake wear detection method according to claim 5, wherein the report information is stored locally in the elevator or stored in a cloud server.

7. The elevator brake wear detection method according to claim 5, wherein when the obtained air gap value exceeds a first preset value, the report information is sent to a user end which comprises user's mobile communication terminal; and/or
when the obtained air gap value exceeds a second preset value, the elevator is controlled to stop running and/or the report information is sent to the user end, the second preset value being larger than the first preset value.

8. The elevator brake wear detection method according to claim 1, wherein an operating time of the elevator comprises an idle period and a busy period, and the method is automatically executed in the idle period with a preset time cycle.

9. An elevator brake wear detection device, wherein the elevator brake comprises a fixed part with an electromagnetic member and a moving part with a friction member; in a first state, the elevator brake drives the moving part to move toward an elevator power device and contact the elevator power device through the friction member to provide a braking force to stop an elevator car, and in a second state, the elevator brake provides an electromagnetic force through the electromagnetic member to disengage the friction member from the contact with the elevator power device; the elevator brake wear detection device comprising a controller which is configured to execute operations comprising:
bringing the elevator brake into the first state, and inputting an electrical signal to the electromagnetic member to generate an electromagnetic field that passes through an air gap between the fixed part and the moving part;
obtaining inductance data or inductance response data of the electromagnetic member under the electromagnetic field; and
based on a preset correspondence model between the inductance of the electromagnetic member and the air gap in the first state, obtaining a corresponding air gap value according to the inductance data to determine a wear state of the friction member, or determining the wear state of the friction member according to the inductance response data.

10. The elevator brake wear detection device according to claim 9, wherein the electromagnetic member is one or more winding coils arranged in a circumferential direction of the fixed part, and the electrical signal is a sinusoidal wave pulse width modulated electrical signal input to the winding coil.

11. The elevator brake wear detection device according to claim 9, wherein the controller is configured to calculate the inductance data according to the following formula:
L=(U/I−R)/2 π*f
where U, I and R are a present voltage, present current and resistance of the electromagnetic member, respectively, and f is a frequency of the electrical signal.

12. The elevator brake wear detection device according to claim 9, wherein the correspondence model is a standard curve model constructed based on the corresponding data of the inductance of the electromagnetic member and the air gap in the first state which are obtained through detection; or the inductance response data comprises current data of the electromagnetic member, a change of at least one current characteristic is judged according to the current data to determine the wear state of the friction member, and the current characteristics comprise current amplitude and current phase.

13. The elevator brake wear detection device according to claim 9, wherein the controller is further configured to execute the steps of:
before bringing the elevator brake into the first state, confirming that the elevator car is currently in a stopped and empty state; and/or
after obtaining the corresponding air gap value, outputting report information related to the wear state of the friction member.

14. The elevator brake wear detection device according to claim 13, wherein the report information is stored locally in the elevator or stored in a cloud server.

15. The elevator brake wear detection device according to claim 13, wherein the controller is further configured to:
when the obtained air gap value exceeds a first preset value, send the report information to a user end which comprises user's mobile communication terminal; and/or
when the obtained air gap value exceeds a second preset value, control the elevator is to stop running and/or send the report information to the user end, the second preset value being larger than the first preset value.

16. The elevator brake wear detection device according to claim 9, wherein an operating time of the elevator comprises an idle period and a busy period, and the controller is configured to automatically execute the operations in the idle period with a preset time cycle.

17. An elevator brake, which is provided with the elevator brake wear detection device according to claim 9.
